(19) United States
(12) Patent Application Publication
(10) Pub. No.: US 2018/0113262 A1
(43) Pub. Date: Apr. 26, 2018

(54) OPTICAL MODULE

(71) Applicant: Oclaro Japan, Inc., Sagamihara (JP)

(72) Inventors: Tetsuya AOKI, Sagamihara (JP); Hiroki IRIE, Fujisawa (JP); Hiroyoshi ISHII, Yokohama (JP); Toshikazu OHTAKE, Yokohama (JP)

(21) Appl. No.: 15/696,485

(22) Filed: Sep. 6, 2017

(30) Foreign Application Priority Data
Oct. 24, 2016 (JP) 2016-208087

(51) Int. Cl. G02B 6/44; G02B 6/42

(52) U.S. Cl. CPC G02B 6/4441; G02B 6/4249; G02B 6/428

(57) ABSTRACT

An optical module includes: a housing including an optical port in one of side surfaces opposite each other and an electric port in the other; an optical fiber disposed inside the housing and connected to the optical port; and an optical subassembly disposed inside the housing, optically connected to the optical fiber, and electrically connected to the electric port. The optical fiber is disposed so as to wind around the optical subassembly at least one turns in a plan view.

### CROSS-REFERENCE TO RELATED APPLICATION

The present application claims priority from Japanese application JP2016-208087 filed on Oct. 24, 2016, the content of which is hereby incorporated by reference into this application.

### BACKGROUND OF THE INVENTION

### 1. Field of the Invention

The present invention relates to an optical module.

### 2. Description of the Related Art

An optical module incorporating optical subassemblies such as a transmitter optical subassembly (TOSA) and a receiver optical subassembly (ROSA) and transmitting and receiving an optical signal has been known.

JP 2011-033644 A discloses an optical module including a tray in which an optical fiber optically connected to an optical subassembly is wounded and which is pulled out with the optical fiber.

An optical fiber for transmitting an optical signal may be disposed in a housing of an optical module. When the bend radius of the optical fiber is equal to or less than the minimum allowable radius, the loss of optical signal intensity, light reflection, or the like is caused and thus transmission characteristics are degraded. Therefore, the optical fiber needs to be contained in the housing at a bend radius equal to or larger than the minimum allowable radius. In recent years, however, the miniaturization of the optical module has progressed, so that the optical fiber disposed in the housing needs to be placed in a narrower region. Therefore, the optical fiber may be contained in the housing while being reduced in bend radius, which involves a risk of degrading the reliability of transmission of an optical signal by the optical fiber.

### SUMMARY OF THE INVENTION

It is therefore an object of the invention to provide an optical module that achieves both the miniaturization thereof and high reliability of transmission of an optical signal.

(1) In order to solve the above problem, an aspect of the invention is directed to an optical module including: a housing including an optical port in one of side surfaces opposite each other and an electric port in the other; an optical fiber disposed inside the housing and connected to the optical port; and an optical subassembly disposed inside the housing, optically connected to the optical fiber, and electrically connected to the electric port, wherein the optical fiber is disposed so as to wind around the optical subassembly at least one turns in a plan view.

(2) The optical module according to (1), wherein the optical fiber is disposed, in the plan view, between a first inner wall of the housing extending in a longitudinal direction thereof and the optical subassembly and between a second inner wall of the housing opposite the first inner wall and the optical subassembly.

(3) The optical module according to (2), wherein the optical fiber includes a splice section, and the splice section is disposed along at least one of the first inner wall and the second inner wall.

(4) The optical module according to any one of (1) to (3), further including one or a plurality of boards disposed inside the housing and electrically connected with the optical subassembly and a control circuit that controls the optical subassembly, wherein the optical fiber is disposed so as to wind around the control circuit at least one turns in the plan view.

(5) The optical module according to (4), further including a tray disposed inside the housing and having an external shape along an inner wall of the housing extending in a longitudinal direction thereof, wherein the optical fiber is accommodated in the tray so as to be along the inner wall in the longitudinal direction of the housing.

(6) The optical module according to (5), wherein the tray is disposed so as to overlap the board in the plan view.

(7) The optical module according to (5) or (6), wherein the tray includes a holding section that holds the board by interposing the board therein.

(8) The optical module according to any one of (5) to (7), wherein the optical fiber includes a first optical fiber optically connected to the optical port and a plurality of second optical fibers optically connected to the optical subassembly, the optical module further includes a multiplexer that combines optical signals input from the plurality of second optical fibers and outputs the combined optical signal to the first optical fiber, and the multiplexer is disposed so as to overlap the tray in the plan view.

(9) The optical module according to any one of (5) to (7), wherein the optical fiber includes a first optical fiber optically connected to the optical port and a plurality of second optical fibers optically connected to the optical subassembly, the optical module further includes a demultiplexer that distributes an optical signal input from the first optical fiber and outputs to the plurality of second optical fibers, and the demultiplexer is disposed so as to overlap the tray in the plan view.

(10) The optical module according to any one of (5) to (9), wherein the tray includes an opening in which the optical subassembly is disposed.

According to the aspect of the invention, the optical module achieving both the miniaturization thereof and high reliability of transmission of an optical signal is provided.

### BRIEF DESCRIPTION OF THE DRAWINGS

FIG. 1 is a perspective view of an optical module according to an embodiment of the invention.

FIG. 2 is a plan view of an optical module according to an embodiment of the invention.

FIG. 3 is a plan view illustrating the arrangement of a first optical fiber incorporated into an optical module according to an embodiment of the invention.

FIG. 4 is a plan view illustrating the arrangement of a second optical fiber incorporated into an optical module according to an embodiment of the invention.

FIG. 5 is a side view of an optical module according to an embodiment of the invention.

### DETAILED DESCRIPTION OF THE INVENTION

Hereinafter, embodiments of the invention will be specifically described in detail based on the drawings. Members having the same function are denoted by the same reference characters throughout the drawings for describing the embodiments, and a redundant description thereof is omitted. The drawings shown below are only for the purpose of describing examples of the embodiments. The sizes of the drawings and the scales described in the embodiments are not always identical.

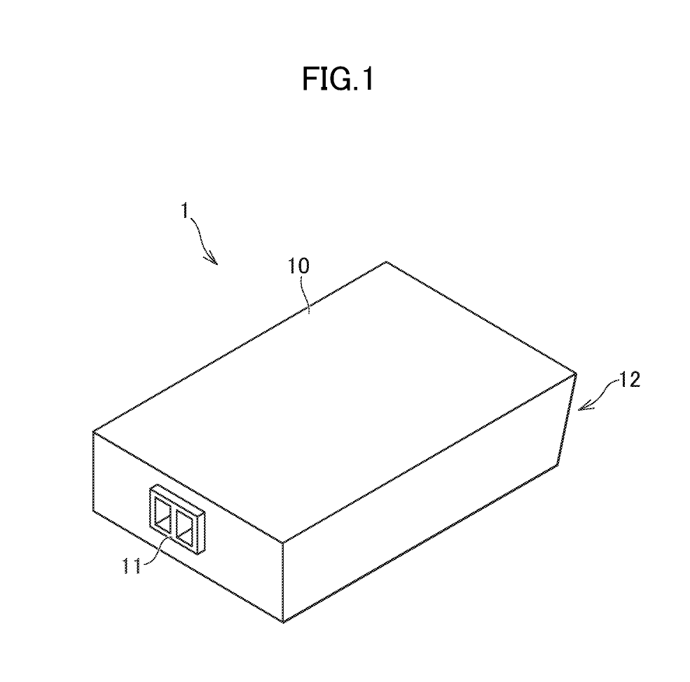

FIG. 1 is a perspective view of an optical module 1 according to an embodiment of the invention. The optical module 1 outputs, with a transmitter optical subassembly (TOSA) incorporated into a housing 10, an optical signal in response to an externally input electric signal, and outputs, with a receiver optical subassembly (ROSA), an electric signal in response to an externally input optical signal. The TOSA and the ROSA are collectively referred to as “optical subassemblies 21”. The optical module 1 according to the embodiment is a so-called optical transceiver having a transmitting function and a receiving function; however, the invention of the present application can be applied also to an optical transmitter having only the transmitting function and an optical receiver having only the receiving function.

The housing 10 includes an optical port 11 in one of side surfaces opposite to each other and an electric port 12 in the other. The housing 10 has a substantially cuboid shape, and the shape of the upper surface is a rectangle. The optical port 11 and the electric port 12 are provided so as to opposite each other in the side surfaces respectively connected to the two short sides of the upper surface (rectangle) of the housing 10. The optical port 11 includes an input-side port to transmit an optical signal that is input to the optical subassembly 21, and an output-side port to transmit an optical signal that is output from the optical subassembly 21, and the optical signal is input or output through the optical port 11 to or from an optical fiber inserted from the outside. The electric port 12 is a port through which an electric signal is input from or output to the optical subassembly 21 or a control circuit 26.

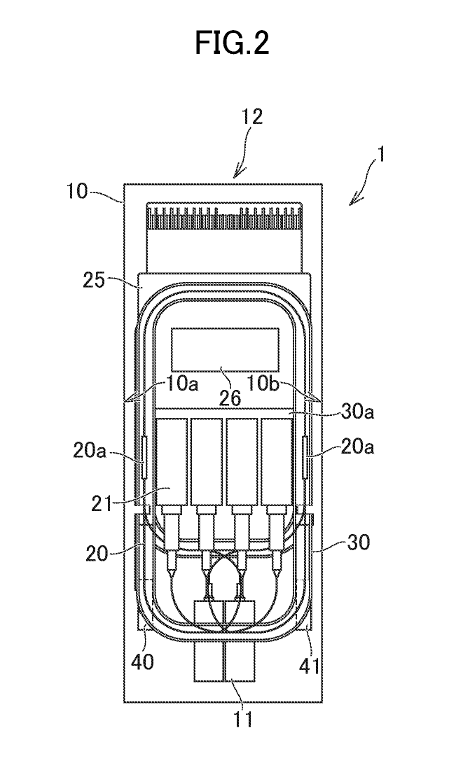

FIG. 2 is a plan view of the optical module 1 according to an embodiment of the invention. FIG. 2 shows the inside of the optical module 1 as viewed in the state where the upper lid of the housing 10 is removed therefrom. The optical module 1 includes optical fibers 20 disposed inside the housing 10 and optically connected to the optical port 11. Moreover, the optical module 1 includes the optical subassemblies 21 disposed inside the housing 10, optically connected to the optical fibers 20, and electrically connected to the electric port 12. The optical module 1 according to the embodiment includes four optical subassemblies 21. Two optical subassemblies 21 disposed on the left side in FIG. 2 are transmitter optical subassemblies (TOSAs), while optical subassemblies 21 disposed on the right side in FIG. 2 are receiver optical subassemblies (ROSAs). One optical fiber 20 is optically connected to each of the four optical subassemblies 21. The optical subassembly 21 is optically connected to the optical fiber 20 on the optical port 11 side, and electrically connected to the control circuit 26 to be described later on the electric port 12 side. A wiring line such as a higher-frequency transmission line can be shortened by electrically connecting the optical subassembly 21 with the control circuit 26 on the electric port 12 side, so that it is possible to drive the optical subassembly 21 with high efficiency and high accuracy.

The optical fiber 20 is disposed so as to go around the optical subassemblies 21 in a plan view. For example, the optical fiber 20 winds around the optical subassemblies 21 at least one turns. The optical fiber 20 is disposed so as to also pass through a portion that is closer to the electric port 12 than the optical subassemblies 21 in the housing 10. The optical subassembly 21 is a relatively large optical component and occupies a large portion of the space in the housing 10 miniaturized. For example, when the optical fiber 20 and the optical subassembly 21 are disposed in different regions as disclosed in, for example, JP 2011-33644 A, the bend radius of the optical fiber 20 is reduced and thus transmission characteristics may be degraded. According to the optical module 1 according to the embodiment, the optical fiber 20 is disposed so as to go around (e.g., at least one turns) the optical subassemblies 21 in the plan view and passes through the portion closer to the electric port 12 than the optical subassembly 21 in the housing 10. Therefore, the bend radius of the optical fiber 20 is kept equal to or larger than the minimum allowable radius, so that both the miniaturization of the housing 10 and excellent transmission characteristics of an optical signal are obtained. The allowable bend radius of the optical fiber 20 is, for example, 10 mm. The optical fiber 20 may not be necessarily disposed so as to wind around the optical subassemblies 21 at least one turns. For example, the optical fiber 20 may not wind so as to form at least one complete circle of 360° around the optical subassemblies 21, and may pass by at least both side surfaces (a first inner wall 10a side and a second inner wall 10b side in FIG. 2) opposite the plurality of the optical subassemblies 21.

The housing 10 includes the first inner wall 10a extending in the longitudinal direction of the housing 10 and the second inner wall 10b opposite the first inner wall 10a. The first inner wall 10a and the second inner wall 10b constitute the side surfaces of the housing 10, and interpose the optical fibers 20 and the optical subassemblies 21 therebetween. The optical fiber 20 is disposed, in the plan view, between the first inner wall 10a and the optical subassembly 21 and between the second inner wall 10b and the optical subassembly 21. A space linearly extending in the longitudinal direction of the housing 10 spreads between the first inner wall 10a and the optical subassembly 21 and between the second inner wall 10b and the optical subassembly 21, which secures a long region in which the optical fiber 20 can be disposed without being bent with the bend radius of the optical fiber 20 kept equal to or larger than the minimum allowable radius. For this reason, the degradation of an optical signal due to the bending of the optical fiber 20 is suppressed, and high reliability of transmission of the optical signal is ensured.

The optical fiber 20 includes splice sections 20a. The splice section 20a is a joint portion of two optical fibers, and is generally a portion at which the fibers are melted and rejoined together. The rejoined region is inferior in bending resistance, and therefore, it is preferable not to bend the rejoined region as much as possible. Further, the splice section 20a is used in many cases with a sleeve surrounded therearound and having a cylindrical shape or the like for preventing the bending of the splice section 20a, and may have a diameter larger than that of the other portion. The optical fiber 20 is prepared in the state of being optically connected to each of the optical port 11, the optical subassembly 21, a multiplexer 40 to be described later, and a demultiplexer 41 to be described later. Therefore, in order to optically connect, for example, the optical port 11 with the multiplexer 40, an optical fiber that is optically connected to the optical port 11 and an optical fiber that is optically connected to the multiplexer 40 need to be joined together, and thus the splice section 20a is formed by joining.

In the optical module 1 according to the embodiment, the splice section 20a is disposed along at least one of the first inner wall 10a and the second inner wall 10b. Since the linearly extending space spreads between the first inner wall 10a and the optical subassembly 21 and between the second inner wall 10b and the optical subassembly 21, the splice section 20a can be linearly disposed without being bent in the region by disposing the splice section 20a along at least one of the first inner wall 10a and the second inner wall 10b. Further, even the splice section 20a with a relatively large diameter can be disposed without deformation or interference with the other members. Especially the first inner wall 10a and the second inner wall 10b can secure some space also in the vertical direction (a direction vertical to the paper surface of FIG. 2), a plurality of splice sections 20a can be disposed to overlap each other in the vertical direction.

The optical module 1 includes one or more of boards 25 disposed inside the housing 10 and electrically connected with the optical subassemblies 21 and the control circuit 26 controlling the optical subassemblies 21. The board 25 is electrically connected to a terminal section of the electric port 12, and the terminal section is electrically connected with the control circuit 26. In FIG. 2, the control circuit 26 is illustrated as one integrated circuit (IC); however, the control circuit 26 may be composed of a plurality of ICs. One board 25 is illustrated in FIG. 2, however, a plurality of boards electrically connected to each other may be disposed in the housing 10.

The optical fiber 20 is disposed, in the plan view, so as to wind around the control circuit 26 at least one turns or also pass through the portion closer to the electric port 12 than the optical subassemblies 21 in the housing 10. In the optical module 1 according to the embodiment, relatively large members such as the optical subassembly 21 and the control circuit 26 is disposed in the center of the housing 10, and the optical fiber 20 is disposed so as to wind around the optical subassemblies 21 at least one turns or the control circuit 26. Therefore, the optical fiber 20 can be disposed as linearly as possible, and thus it is possible to prevent, for example, the occurrence of loss of optical signal intensity due to the bending of the fiber.

The optical module 1 further includes a tray 30 disposed inside the housing 10 and having an external shape along the inner walls (the first inner wall 10a and the second inner wall 10b) of the housing 10 extending in the longitudinal direction thereof. The optical fiber 20 is accommodated in the tray 30 so as to be along the inner walls (the first inner wall 10a and the second inner wall 10b) in the longitudinal direction of the housing 10. The tray 30 is adjacent to the first inner wall 10a and the second inner wall 10b. The tray 30 has a rectangular shape with rounded corners in the plan view, and includes a guide for accommodating the optical fiber 20. The tray 30 has a width approximately equal to the distance from the first inner wall 10a to the second inner wall 10b of the housing 10, and is fixed so as to be fit into the housing 10. The guide of the tray 30 is formed so as to be along the inner walls of the housing 10 extending in the longitudinal direction thereof. By accommodating the optical fiber 20 in the tray 30, the optical fiber 20 can be disposed along the inner walls in the longitudinal direction of the housing 10, so that the optical fiber 20 can be disposed as linearly as possible. Moreover, by accommodating the optical fiber 20 in the tray 30, the optical fiber 20 is prevented from being bent equal to or less than a bend radius defined by the tray 30, so that it is possible to prevent, for example, the occurrence of loss of optical signal intensity due to the bending of the fiber.

The tray 30 is disposed so as to overlap the board 25 in the plan view. The board 25 is installed together with the tray 30 in the housing 10 in the state where the board 25 is held on the back surface side of the tray 30 (between the tray 30 and the bottom surface of the housing 10) as will be described later. The constituent members of the optical module 1 can be disposed in a limited space inside the housing 10 by disposing the tray 30 and the board 25 so as to overlap each other in the plan view.

The tray 30 includes an opening 30a in which the optical subassembly 21 is disposed. The opening 30a is formed in the center of the tray 30 so as to be surrounded by the guide in which the optical fiber 20 is accommodated. In the case of the optical module 1 according to the embodiment, four optical subassemblies 21 are contained in the opening 30a. The optical subassemblies 21 are contained in the opening 30a of the tray 30, so that the optical subassemblies 21 are temporary aligned before the optical subassemblies 21 are electrically connected to the board 25 and thus assembling is facilitated.

The optical module 1 according to the embodiment includes the multiplexer 40, which combines a plurality of optical signals input from the plurality of optical fibers 20 and outputs the combined optical signal to one optical fiber 20, and the demultiplexer 41, which distributes and outputs an optical signal input from one optical fiber 20 to the plurality of optical fibers 20. In the following, the optical fiber 20 that is optically connected to the optical port 11 is referred to as a “first optical fiber 20b”, and the optical fiber 20 that is optically connected to the optical subassembly 21 is referred to as a “second optical fiber 20c”.

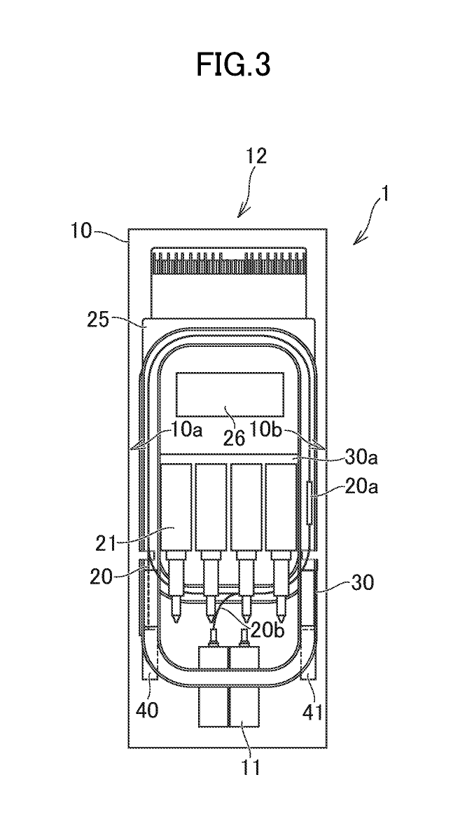

FIG. 3 is a plan view illustrating the arrangement of the first optical fiber 20b incorporated into the optical module 1 according to an embodiment of the invention. The first optical fiber 20b is optically connected to the optical port 11. The first optical fiber 20b is routed along the guide of the tray 30 so as to wind counterclockwise around the optical subassemblies 21 and the control circuit 26 one turn. The first optical fiber 20b goes through the splice section 20a provided between the optical subassembly 21 and the second inner wall 10b, further winds, a half turn, counterclockwise around the optical subassemblies 21 and the control circuit 26, and is optically connected to the multiplexer 40. An excessive length of the first optical fiber 20b can be secured by causing the first optical fiber 20b to wind along the guide of the tray 30 as described above, so that the formation of the splice section 20a (joining of optical fibers) can be easily performed.

In the optical module 1 according to the embodiment, the multiplexer 40 is disposed so as to overlap the tray 30 in the plan view. With this configuration, the constituent members of the optical module 1 can be disposed in a limited space inside the housing 10.

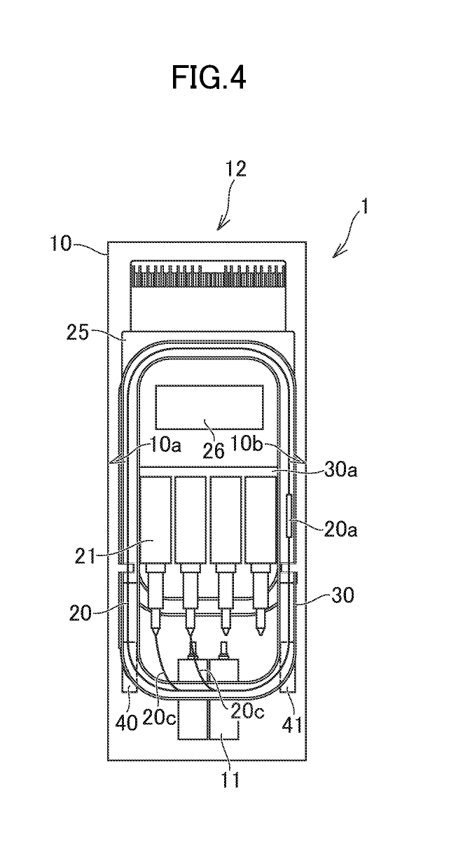

FIG. 4 is a plan view illustrating the arrangement of the second optical fiber 20c incorporated into the optical module 1 according to an embodiment of the invention. In FIG. 4, two second optical fibers 20c that are optically connected respectively to two optical subassemblies 21 (transmitter optical subassemblies) are illustrated. The two second optical fibers 20c are routed along the guide of the tray 30 so as to wind counterclockwise around the optical subassemblies 21 and the control circuit 26 one turn. The two second optical fibers 20c go through the splice section 20a provided between the optical subassembly 21 and the second inner wall 10b, further wind, a half turn, counterclockwise around the optical subassemblies 21 and the control circuit 26, and are optically connected to the multiplexer 40. An excessive length of the second optical fiber 20c can be secured by causing the second optical fiber 20c to wind along the guide of the tray 30 as described above, so that the formation of the splice section 20a (joining of optical fibers) can be easily performed.

Here, the tray 30 is divided into three major regions. A first region is a region through which the first optical fiber 20b extending from the optical port 11 first passes. A second region is a region through which the second optical fiber 20c passes and which overlaps the optical port 11 in the plan view. A third region is a region other than the first and second regions, which is disposed mainly around the optical subassemblies 21 or the control circuit 26. The first region and the second region are disposed in front (the lower side of FIG. 2) of the optical subassembly 21 at different heights (heights in the vertical direction). More specifically, the second region is disposed so as to pass through the upper portion of the optical port 11, and the first region is disposed so as to pass through the lower portion of the tip portion (a so-called receptacle or a sleeve portion) of the optical subassembly 21. A structure in which a difference in level is provided between the first region and the second region as described above is employed, so that the optical fiber can be efficiently disposed in the optical module. The third region has a depth that spans both the first region and the second region, and thus the splice section 20a, having a large diameter as described above, can be disposed.

The arrangement of the first optical fiber 20b that optically connects the optical port 11 with the demultiplexer 41 and the arrangement of the plurality of second optical fibers 20c that optically connect the plurality of optical subassemblies 21 with the demultiplexer 41 are similar to those of the multiplexer 40 shown in FIGS. 3 and 4, and therefore, the illustration is omitted. The first optical fiber 20b that is optically connected to the demultiplexer 41 is optically connected to the optical port 11. The first optical fiber 20b is routed along the guide of the tray 30 so as to wind, one turn, clockwise around the optical subassemblies 21 and the control circuit 26. The first optical fiber 20b goes through the splice section 20a provided between the optical subassembly 21 and the first inner wall 10a, further wind, a half turn, clockwise around the optical subassemblies 21 and the control circuit 26, and is optically connected to the demultiplexer 41. Two second optical fibers 20c that are optically connected respectively to two optical subassemblies 21 (receiver optical subassemblies) are routed along the guide of the tray 30 so as to wind, one turn, clockwise around the optical subassemblies 21 and the control circuit 26. The second optical fibers 20c go through the splice section 20a provided between the optical subassembly 21 and the first inner wall 10a, further wind, a half turn, clockwise around the optical subassemblies 21 and the control circuit 26, and are optically connected to the demultiplexer 41.

In the optical module 1 according to the embodiment, the demultiplexer 41 is disposed so as to overlap the tray 30 in a plan view. With this configuration, the constituent members of the optical module 1 can be disposed in a limited space inside the housing 10.

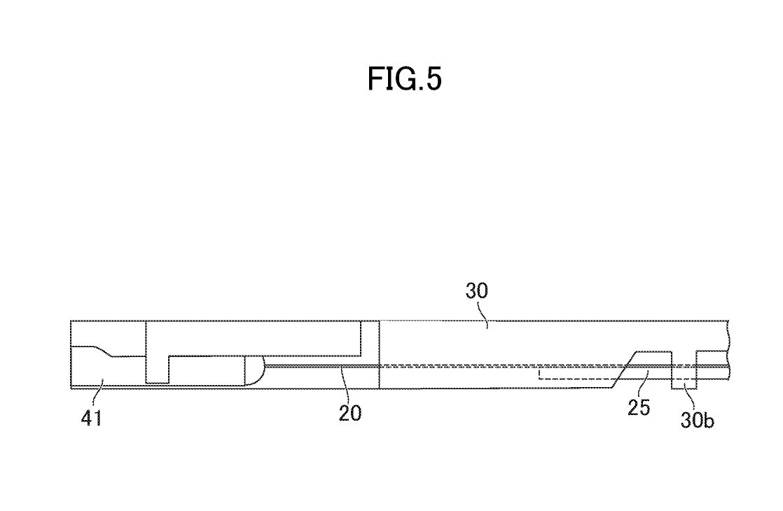

FIG. 5 is a side view of the optical module 1 according to an embodiment of the invention. FIG. 5 illustrates the tray 30, the demultiplexer 41, the optical fiber 20, and the board 25, which are disposed inside the housing 10. The tray 30 includes a holding section 30b that holds the board 25 by interposing the board 25 therein. The holding section 30b is composed of a claw in which the board 25 is interposed. The board 25 is held by the holding section 30b of the tray 30 and is disposed together with the tray 30 inside the housing 10. The board 25 is held by the holding section 30b, so that temporary alignment of the board 25 with the optical subassemblies 21 can be performed before the tray 30 and the board 25 are disposed in the housing 10 and thus assembling is facilitated.

The optical fiber 20 that is optically connected to the demultiplexer 41 is disposed so as to pass on the back side of the tray 30. Here, the back side of the tray 30 is the side where the board 25 is disposed, and is the bottom surface side of the housing 10. The optical fiber 20 is disposed so as to pass on the front side of the tray 30 and wind, at least one turns, around the optical subassembly 21, and passes on the backside of the tray 30 to be optically connected to the demultiplexer 41 or the multiplexer 40. The constituent members of the optical module 1 can be disposed in a limited space inside the housing 10 by three-dimensionally disposing the optical fiber 20 as described above.

Although an example in which the optical fiber 20 is disposed so as to wind around the optical subassemblies 21 and the control circuit 26 one turn has been shown, it does not matter that the optical fiber 20 winds two or more turns in order to secure an excessive length. Further, it is sufficient that the splice section 20a is provided as necessary. Even when the splice section 20a is not provided, the advantageous effects of the invention are obtained.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An optical module comprising:
a housing including an optical port in one of side surfaces opposite each other and an electric port in the other;
an optical fiber disposed inside the housing and optically connected to the optical port; and
an optical subassembly disposed inside the housing, optically connected to the optical fiber, and electrically connected to the electric port, wherein
the optical fiber is disposed so as to wind around the optical subassembly at least one turns in a plan view.

2. The optical module according to claim 1, wherein
the optical fiber is disposed, in the plan view, between a first inner wall of the housing extending in a longitudinal direction thereof and the optical subassembly and between a second inner wall of the housing opposite the first inner wall and the optical subassembly.

3. The optical module according to claim 2, wherein
the optical fiber includes a splice section, and
the splice section is disposed along at least one of the first inner wall and the second inner wall.

4. The optical module according to claim 1, further comprising one or a plurality of boards disposed inside the housing and electrically connected with the optical subassembly and a control circuit that controls the optical subassembly, wherein
the optical fiber is disposed so as to wind around the control circuit at least one turns in the plan view.

5. The optical module according to claim 4, further comprising a tray disposed inside the housing and having an external shape along an inner wall of the housing extending in a longitudinal direction thereof, wherein
the optical fiber is accommodated in the tray so as to be along the inner wall in the longitudinal direction of the housing.

6. The optical module according to claim 5, wherein
the tray is disposed so as to overlap the board in the plan view.

7. The optical module according to claim 5, wherein
the tray includes a holding section that holds the board by interposing the board therein.

8. The optical module according to claim 5, wherein
the optical fiber includes a first optical fiber optically connected to the optical port and a plurality of second optical fibers optically connected to the optical subassembly,
the optical module further comprises a multiplexer that combines optical signals input from the plurality of second optical fiber and outputs the combined optical signal to the first optical fiber, and
the multiplexer is disposed so as to overlap the tray in the plan view.

9. The optical module according to claim 5, wherein
the optical fiber includes a first optical fiber optically connected to the optical port and a plurality of second optical fibers optically connected to the optical subassembly,
the optical module further comprises a demultiplexer that distributes an optical signal input from the first optical fiber and outputs to the plurality of second optical fibers, and
the demultiplexer is disposed so as to overlap the tray in the plan view.

10. The optical module according to claim 5, wherein
the tray includes an opening in which the optical subassembly is disposed.
